(19) United States
(12) Patent Application Publication
(10) Pub. No.: US 2009/0314926 A1
(43) Pub. Date: Dec. 24, 2009

(54) SOLAR PLATFORM

(75) Inventors: Thomas Hinderling, Bern (CH); Yassine Allani, Diablerets (CH)

Correspondence Address: YOUNG & THOMPSON, 209 Madison Street, Suite 500, Alexandria, VA, 22314, US

(73) Assignee: CSEM Centre Suisse d'Electronique et de Microtechnique SA, Neuchatel (CH)

(21) Appl. No.: 12/375,594

(22) PCT Filed: Jul. 3, 2007
(86) PCT No.: PCT/EP2007/056658

§ 371 Date: May 29, 2009

(30) Foreign Application Priority Data
Jul. 29, 2006 (CH) 122706

(51) Int. Cl. G01J 1/20; G01C 21/02

(52) U.S. Cl. 250/203.4

(57) ABSTRACT

A floating solar platform includes a bridge (10, 5, 21) connected to buoyancy elements (11), elements (14, 23) for collecting received solar energy, the elements being associated with the bridge and placed thereon, elements (16, 24) for converting this energy, elements (19) for storing the product of this conversion, and first propulsion elements (12) for moving the platform to sites where it can benefit from optimum sunshine. The platform further includes elements for controlling its paths, which elements act on the propulsion elements and include a navigation system associated with an algorithm for predictively optimizing the position in terms of latitude and longitude, taking into account the local meteorological conditions or particular logistic data for the optimum choice of its location.

### FIELD OF THE INVENTION

The present invention generally relates to the area of utilizing solar energy. It more particularly concerns a floating solar platform allowing optimal collection of solar energy, and the conversion and storage thereof.

More specifically, the invention concerns the search for a solution to the issue of the depletion of hydrocarbon resources, and to the end of the inexpensive oil era.

Solar thermal power plants of the “on-shore” type require a large ground surface area and are subject to various problems such as: sandstorms leading to accelerated abrading of mirrors or photovoltaic panels, cycles of day-night humidity causing fouling and high maintenance costs with deterioration of functional surfaces. In addition, said systems require expensive electricity transport infrastructures. Finally an increase in ambient temperature penalizes the energy efficiency of thermodynamic cycles (temperature of the cold source) and even of the photovoltaic systems (the higher the junction temperature, the lower the yield).

These difficulties may be overcome by resorting to platforms floating on a liquid surface. One such platform is described for example in document U.S. Pat. No. 4,786,795. It is provided with rotating means providing it with optimal reception of sun rays, but has the major disadvantage of being anchored on the water floor, making it dependent upon local sunlight conditions.

### DESCRIPTION OF RELATED ART

Document DE 197 58 309 describes a solar ship which, under orders given by a navigation system, is capable of navigating towards places where it may benefit from maximum sunlight.

It is true that document U.S. Pat. No. 7,047,114 proposes an optimization algorithm for a ship's navigation paths, but it is solely used to protect against risks of collision and storms.

One of the purposes of the present invention is to provide a “super-intelligent” floating solar platform, capable of offering best performance at all times.

### SUMMARY OF THE INVENTION

More specifically, the invention concerns a floating solar platform comprising a bridge linked to buoyancy elements, collector means associated with said bridge for collecting received solar energy, and arranged on the latter, means for converting this energy, means for storing the product of this conversion, first propelling means for moving the platform towards locations where it may benefit from maximum sunlight, means for controlling its travel paths which act on said propelling means and comprise a navigation system associated with a predictive algorithm for optimization of latitude and longitude positioning, having regard to local weather conditions or to particular logistic data for optimum choice of location, characterized in that said algorithm additionally enables adjustment of the position of the platform in relation to the day's date at the location in which it lies.

According to one first advantageous embodiment, said collector means are arranged on the bridge and the platform additionally comprises second propelling means for causing it to undergo gyroscopic rotation about a central vertical axis to maximize received sunlight.

According to a second advantageous embodiment, the platform is associated with floating mini-platforms and said collector means are positioned thereupon, in which case they comprise second propelling means for causing them to undergo gyroscopic rotation about a central vertical axis to maximize received sunlight.

### BRIEF DESCRIPTION OF THE DRAWINGS

Other characteristics and advantages of the invention will become apparent from the following description given with reference to the appended drawings wherein:

FIG. 1 illustrates a rotatable platform with global gyroscopic positioning;

FIG. 2 illustrates an assembly consisting of a central platform and collector elements, or rotatable mini-platforms,

FIGS. 3 and 4 provide different views of an extra-flat concentrator which may be used on platforms of the invention.

### DETAILED DESCRIPTION OF THE INVENTION

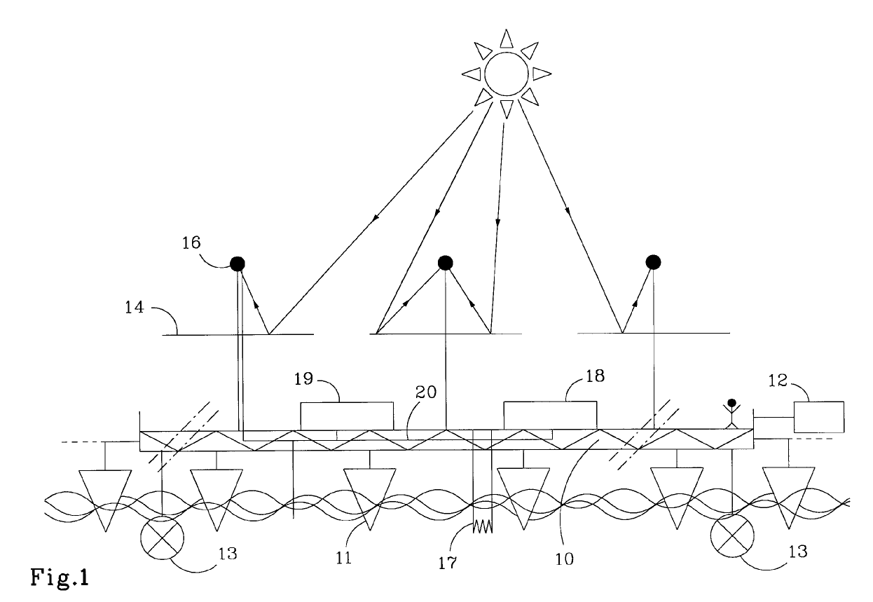

The base of the platform schematically illustrated in FIG. 1 consists of an outspread bridge of hollow construction by means of lightweight triangular structures for example, with crossbeams. Buoyancy floaters 11 are integrated into these structures. Alternatively, these may be replaced by slightly pressurized floating cushions.

Propelling means 12 are used for moving the platform towards locations where it may benefit from optimum sunlight. Advantageously, the travel paths followed by the platform may be controlled using a GPS system associated with a predictive algorithm for optimization of latitude and longitude positioning, which is based on Cook's law for example (see http://fred.elie.free.fr/cadrans_solaires.htm). By comparison with the solution whereby a platform is held in a fixed position, this capacity to adjust position according to date enables a gain in efficiency (global energy yield) in the order of 15%. Additionally, the optimization algorithm may advantageously take local weather conditions into consideration, or particular logistic data, for optimum choice of location.

The tracking of the apparent movement of the sun and the stabilized positioning of the platform to counter the effect of the wind and waves is achieved by means of gyroscopic rotation of the assembly about a central vertical axis, to maximize received sunlight. This tracking by rotation is ensured by a group of at least three hydro-propellers 13 (of which only two are shown in the drawing) arranged in an equilateral triangle. The thrust of each hydro-propeller is servo-controlled, gyroscopic adjustment being achieved for example in manner known per se by means of three laser beams with GPS positioning.

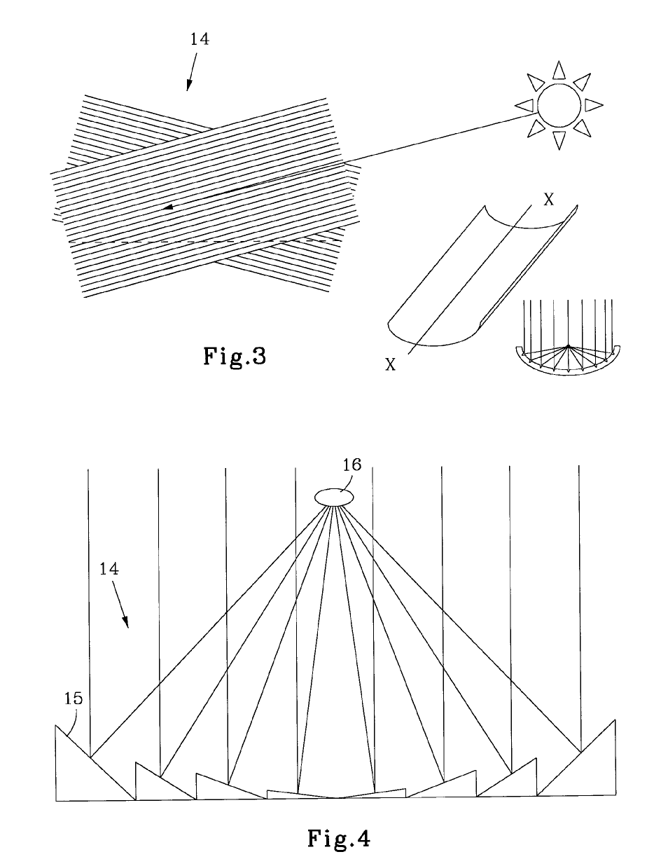

The platform is equipped with a plurality of concentrators 14 e.g. of extra-flat reflector type which advantageously consist of flat plates 15 of various widths and with different tilt angles, as shown in FIG. 3, which are arranged parallel and symmetrically with respect to a horizontal axis XX. The tilt angle for a flat plate of order “i” is the solution of a ninth degree polynomial equation, with the tangent of the tilt half-angle as variable. This solution maximizes the energy collected at the optical spot focus 16 of the concentrator when this coincides with its geometrical spot focus, whilst reducing detrimental space between the flat plates.

The optical spot focus 16 of the concentrator is occupied by a horizontal boiler tube which directly receives the concentrated light. In one alternative embodiment (not shown) sunlight may be received by means of a secondary reflector with symmetrical twin mirrors and adjustable aperture depending on the time of the day. The purpose is to maximize the rate of concentration, automatically and through self-adjustment, irrespective of the time of day.

The concentrators 14, arranged horizontally on the platform may either be fixed, or pivotably mounted about the horizontal axis XX. In the former case, the rows of concentrators are arranged side by side being separated by a very small detrimental space (no more than 10% of the width of a row). In the second case, the rows are pivotably mounted using suitable means about an axis XX and lie distant to take the shadow effect into account, but no edge effect is caused subsequent to pivoting of the platform about its vertical axis.

The flat plates 15 are fixed onto a lightweight metal support structure by means of “clips” avoiding any screwing operations or other added parts. Therefore the positioning of the flat plates and their clipping into place may be fully automated when mounting the concentrators on the platform. Advantageously the flat plates may contain tubing for their longitudinal reinforcement.

With the boiler tube arranged at the optical spot focus 16, the collected solar energy may be converted according to the following various possibilities:
direct production of electricity through use of the thermophotovoltaic effect (TPV);
direct production of electricity through the use of photovoltaic cells;
combined direct production of electricity (TPV) and steam (Direct Steam Generation—DSG) for onboard thermodynamic cycles;
combined direct production of electricity (TPV) and hot air for onboard thermodynamic cycles;
direct steam generation (DSG);
direct production of hot air for onboard dynamic cycles; and
combined direct production of steam (DSG) and hot air at high temperature.

The DSG method is ensured by means of coaxial tubes including a layer of material of phase change type (Phase Change Material—PCM) guaranteeing stabilization of the steam-producing temperature. Injection of water for DSG is ensured by means of self-controlled valves.

According to one alternative, extra-flat concentrators may be used which have a point focus, in lieu and stead of concentrators having a line focus as described previously.

Obviously the present invention is not limited to the use of sensors of the type described above, and other sensors such as photovoltaic cells may advantageously be used.

As shown in FIG. 1, the platform further comprises at least one condenser 17 immersed in deep water and used as cold source for the thermodynamic cycles, a power plant 18 for powering local functions, and storage means 19 for storing energy in suitable form (steam, H2, liquid aluminium etc). Finally the presence of collectors 20 is noted, collecting a heat transfer fluid, which connect the boiler tubes to the different aforementioned elements.

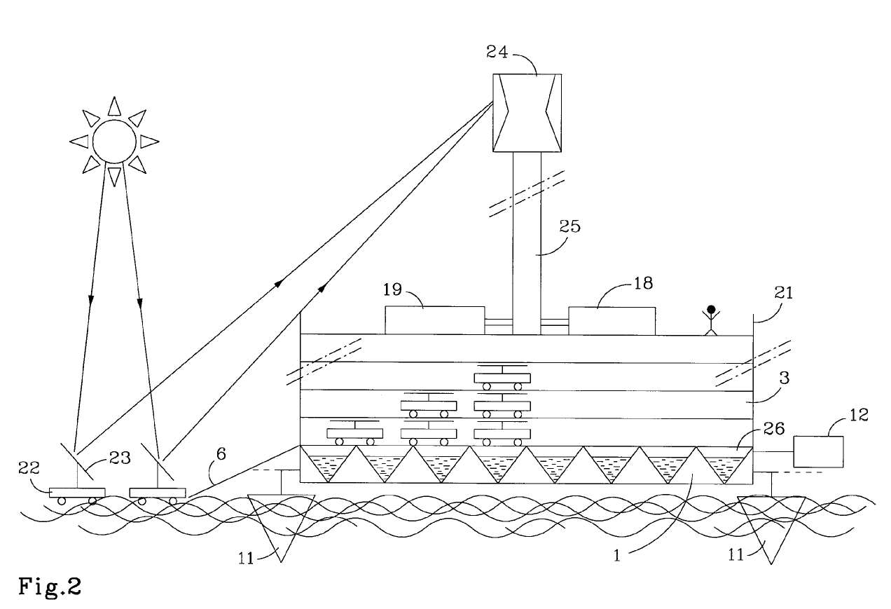

Reference will now be made to FIG. 2 in which identical parts to those in FIG. 1 bear the same reference numbers. In this embodiment, a central bridge 21 which is not able to rotate about itself, is associated with a plurality of floating mini-platforms 22 which bear concentrators 23 identical to those in FIG. 3. The mini-platforms are capable of orienting themselves independently, as are the flat plates of the concentrators as described previously. The light received by the concentrators 23 is directed towards a boiler spot focus 24 arranged at the top of a tower 25 of the platform 21 and intended to perform energy conversion similar to the boiler tubes in FIG. 1. The platform is advantageously arranged to stow away the mini-platforms 22 when they are not in service or for transport. Finally, the bottom of the platform forms a water tank used as a condenser for the steam cycle, and accessorily as a desalination unit.

In addition to the previously described functions, the platform of the invention may be used for developing non-energy activities, such as the production of chlorine by mere electrolysis of seawater required for producing hydrogen, aquaculture and food industry activities related to fishing, the transport of drinking water produced by desalination or any other means.

A floating platform is thereby proposed that is capable both of moving to an ideal location, and of orienting itself and orienting its collectors to achieve optimal exposure to sunrays. The different types of radiation conversion and energy storage that are described make this platform a particularly well-performing tool having largely reduced manufacturing costs (grey energy) compared with land solar plants.

1-13. (canceled)

14. A floating solar platform comprising a bridge linked to buoyancy elements, collector means associated with said bridge to collect received solar energy, and arranged on the latter, means for converting this energy, means for storing the product of this conversion and first propelling means for moving the platform to locations where it may benefit from optimum sunlight, means to control its travel path which act on said propelling means and comprise a navigation system associated with a predictive algorithm for optimization of latitude and longitude positioning, having regard to local weather conditions or to particular logistic data for optimum choice of location, wherein said algorithm further enables adjustment of the platform's position in relation to the day's date at the location in which it lies.

15. The platform of claim 14, wherein said collector means are arranged on the bridge and wherein said platform also comprises second propelling means for causing it to undergo gyroscopic rotation about a central vertical axis to maximize received sunlight.

16. The platform of claim 14, which is associated with floating mini-platforms, wherein said collector means are arranged thereupon and wherein said mini-platforms comprise second propelling means for causing them to undergo gyroscopic rotation about a central vertical axis to maximize received sunlight.

17. The platform of claim 15, wherein said propelling means comprise hydro-propellers controlled by a GPS system.

18. The platform of claim 16, wherein said propelling means comprise hydro-propellers controlled by a GPS system.

19. The platform according to claim 14, wherein said collector means comprise photovoltaic cells.

20. The platform according to claim 15, wherein said collector means comprise photovoltaic cells.

21. The platform according to claim 16, wherein said collector means comprise photovoltaic cells.

22. The platform according to claim 17, wherein said collector means comprise photovoltaic cells.

23. The platform according to claim 18, wherein said collector means comprise photovoltaic cells.

24. The platform according to claim 14, wherein said collector means comprise concentrators having a line focus.

25. The platform of claim 24, wherein said concentrators consist of flat plates of various widths and different tilt angles, which are arranged parallel and symmetrically relative to a horizontal axis (XX).

26. The platform of claim 25, wherein said concentrators are fixed.

27. The platform of claim 25, wherein said concentrators may pivot so as to receive maximum sunlight whilst avoiding any shadow effect.

28. The platform of claim 24, wherein said conversion means consist of a boiler tube arranged at the spot focus of said concentrators.

29. The platform of claim 25, wherein said conversion means consist of a boiler tube arranged at the spot focus of said concentrators.

30. The platform of claim 26, wherein said conversion means consist of a boiler tube arranged at the spot focus of said concentrators.

31. The platform of claim 27, wherein said conversion means consist of a boiler tube arranged at the spot focus of said concentrators.

32. The platform according to claim 14, wherein said collector means comprise concentrators having a point focus.

33. The platform according to claim 32, wherein said conversion means consist of a boiler arranged at the spot focus of said concentrators.

34. The platform according to claim 14, wherein said conversion means are adapted for performing at least one of the following functions:
direct production of electricity through use of the thermophotovoltaic effect (TPV), the tube being coated with a photovoltaic layer;
combined direct production of electricity (TPV) and steam (Direct Steam Generation—DSG) for onboard thermodynamic cycles;
combined direct production of electricity (TPV) and hot air for onboard thermodynamic cycles;
direct steam generation (DSG);
direct production of hot air for onboard dynamic cycles; and
combined direct production of steam (DSG) and hot air at high temperature.

35. The platform according to claim 24, wherein conversion means are adapted for performing at least one of the following functions:
direct production of electricity through use of the thermophotovoltaic effect (TPV), the tube being coated with a photovoltaic layer;
combined direct production of electricity (TPV) and steam (Direct Steam Generation—DSG) for onboard thermodynamic cycles;
combined direct production of electricity (TPV) and hot air for onboard thermodynamic cycles;
direct steam generation (DSG);
direct production of hot air for onboard dynamic cycles; and
combined direct production of steam (DSG) and hot air at high temperature.

36. The platform according to claim 32, wherein said conversion means are adapted for performing at least one of the following functions:
direct production of electricity through use of the thermophotovoltaic effect (TPV), the tube being coated with a photovoltaic layer;
combined direct production of electricity (TPV) and steam (Direct Steam Generation—DSG) for onboard thermodynamic cycles;
combined direct production of electricity (TPV) and hot air for onboard thermodynamic cycles;
direct steam generation (DSG);
direct production of hot air for onboard dynamic cycles; and
combined direct production of steam (DSG) and hot air at high temperature.
